(19) United States
(12) Patent Application Publication
(10) Pub. No.: US 2005/0094703 A1
(43) Pub. Date: May 5, 2005

(54) Clothing for measuring and displaying a body temperature

(76) Inventors: Michael T. McConnell, Santa Ynez, CA (US); Thomas E. McConnell, Santa Ynez, CA (US); Francois Hacquard, Los Angeles, CA (US)

Correspondence Address: Kit M. Stetina, Esq.;STETINA BRUNDA GARRED & BRUCKER, Suite 250, 75 Enterprise, Aliso Viejo, CA, 92656, US

(21) Appl. No.: 10/701,050

(22) Filed: Nov. 4, 2003

(51) Int. Cl. G01K 3/00; G01K 1/00

(52) U.S. Cl. 374/101; 374/208

(57) ABSTRACT

There is provided a clothing for measuring and displaying a temperature of a baby's body and/or the temperature inside the clothing. The clothing first features a clothing body sized and configured to accommodate the baby's body therewithin. The clothing body has inner and outer clothing surfaces. The clothing further features a body temperature device which is engaged to the clothing body and has a temperature measuring member and a temperature displaying member. The temperature measuring member is disposed between the baby's body and the inner clothing surface for measuring the temperature of the baby's body. The temperature displaying member is in communication with the temperature measuring member for receiving the temperature measurement of the baby's body therefrom. The temperature displaying member has a temperature displaying surface which is disposed outside the baby's body and upon the outer clothing surface for displaying a visual indicia representative of the temperature of the baby's body.

### CROSS-REFERENCE TO RELATED APPLICATIONS

(Not Applicable)

### STATEMENT RE: FEDERALLY SPONSORED RESEARCH/DEVELOPMENT

(Not Applicable)

### BACKGROUND OF THE INVENTION

The present invention relates generally to baby clothing, and more particularly to baby clothing that is adapted to measure a temperature directly from a baby's body and/or the temperature inside the clothing and display the same upon an outer surface of the clothing so as to monitor the body temperature of a sleeping baby and prevent serious health risks such as Sudden Infant Death Syndrome and/or sleep apnea.

Understandably, parents or other caretakers are often concerned whether babies are dressed appropriately for the temperature of their environment. If the babies are underdressed, then they are at risk of catching a common cold or a flu which can lead to fever or other health complications. Conversely, if babies are overdressed, then the babies may become overheated resulting in dehydration and other complications such as heat rashes due to the soft nature of their skins.

Parents particularly worry about their babies dress when the babies are sleeping since the implications resulting from overdressing extend far beyond than mere flu or sweat rashes. Although specific causes are unknown, it is suspected that one of the causes for serious health risks such as Sudden Infant Death Syndrome (SIDS) and/or sleep apnea may be due to overheating which may be caused by dressing the babies too warmly when they go to sleep. Thus, such health risks may be preventable by maintaining the babies optimal body temperature (i.e., 98.6° F./37.5° C.) during their sleep.

In order to appropriately control the babies body temperature, parents typically dress up their babies in night shirts, sleeper pajamas or sleep sacks before tucking them into their cribs. With such serious health risks in mind, as well as the parents' concern for the common cold or the flu, parents frequently unzip or unbutton their babies' clothing in order to manually feel the babies' chest, tummy or legs in order to estimate the body temperature of their babies as they sleep.

However, such manner of estimating the babies' body temperature by physical touching may be unreliable to accurately measure the baby's body temperature. Although a parent's hand may sense extreme levels of body temperature, it cannot, however, sense the ranges of body temperature which are between those extreme levels. As such, parents often miss minor elevations in body temperature, or more importantly the ones which are on the rise to extremities. The latter, of course, may expose the babies to serious health risks such as SIDS and/or sleep apnea.

Further deficiency in the physical touching estimation of body temperature lies in the impracticality of such method as parents unzip or unbutton the clothing of the baby and manually place his or her hand upon the baby and many times the baby is disturbed from sleep and becomes fully awake. Obviously, this can result in an uncontrollable crying or severe temper tantrum which may last throughout the night. Such reactions tend to discourage the parents from repetitively checking upon their babies, hence potentially jeopardizing their welfare.

In view of the above-described shortcomings of the conventional method of manually estimating the baby's body temperature, there exists a need in the art for baby clothing that can accurately measure and conveniently display all ranges of a baby's body temperature on a continual basis. More specifically, there exists a need for a baby clothing which can perform such function without disturbing and/or awakening the baby from his or her sleep. By providing a baby clothing which satisfies both needs, parents may monitor and safeguard their babies from serious health risks such as SIDS and/or sleep apnea without resorting to the burdensome task of clothes unzipping or unbuttoning merely for estimating (not measuring) the babies' body temperature with their hands.

### BRIEF SUMMARY OF THE INVENTION

The present invention specifically addresses and alleviates the above-referenced deficiencies associated with the conventional method of manually estimating a baby's body temperature. More particularly, the present invention is a unique baby clothing which accurately measures a temperature directly from a baby's body and/or the temperature inside the clothing and conveniently displays the same upon the outer surface of the clothing. This stated function may be performed continuously throughout the day but is especially beneficial during times when the baby is sound asleep. As will be demonstrated below, the present baby clothing's adaptability to readily monitor the baby's body temperature serves to be a very effective measure against various types of health risks such as fever, common cold and/or flu, but more importantly against serious health risks such as SIDS and/or sleep apnea which can occur suddenly when the baby is asleep.

In accordance with a preferred embodiment of the present invention, there is provided a unique type of clothing which allows a parent to accurately, conveniently and readily monitor the body temperature of his or her baby. The baby clothing of the present invention first features a clothing body that can accommodate a baby's body therewithin. Preferably, the baby clothing is a sleepwear such as a pajama or a sleep sack which is designed to be worn when the baby goes to sleep. However, the baby clothing may alternatively be a daywear such as a sweater that may be worn during daytime hours.

In the preferred embodiment of the present invention, the baby clothing further features a body temperature device which functions to monitor the baby's body temperature and/or the temperature inside the clothing. This temperature device engages the clothing body in a manner as to measure the temperature from the inside of the clothing and/or directly from the baby's body and display the same upon the outer surface of the clothing body. In this respect, the baby's temperature may be accurately assessed and be conveniently visualized by the parent.

As will be explained in detail below, the body temperature device utilized in the present invention may be constructed according to various embodiments to achieve such specific type of engagement to the clothing body. However, it should be noted that all of the different embodiments of the temperature device adheres to the following general specifications.

In all the embodiments, the body temperature device is comprised of a temperature measuring member and a temperature displaying member which are placed on opposite sides of the clothing body. More specifically, the measuring member of the temperature device is positioned between the baby's body and the inner surface of the clothing body. Upon such disposition, the measuring member abuts its temperature measuring surface against the baby's body so that its temperature may be monitored continuously for a prolonged amount of time, or at least until the clothing is taken off from the baby. Alternatively, the measuring member monitors the temperature inside the clothing which would have a direct correlation with the baby's body temperature. Additionally, it is expressly noted herein that all pieces of the device in whatever embodiment should be large enough so that components of the same cannot be aspirated or cause choking in an infant or child.

Furthermore, the displaying member in all the embodiments of the body temperature device is positioned on or through the outer surface of the clothing body and exposes its temperature displaying surface externally thereupon. This allows the displaying surface to be readily visible by the parent, hence providing a tangible temperature reading for the parent. The temperature displaying member is placed in electrical communication with the measuring member and continuously receives the body temperature measurements therefrom. Upon their reception, the displaying member displays visual indicia, which are representative of the temperature measurements, through its displaying surface for the parents to observe. Alternatively, the temperature displaying member may be heat activated by the body temperature generated from the baby's body.

The visual indicia shown on the temperature displaying surface may be in various forms. One form of indicia that may be used to visualize the baby's body temperature is a scale system of assorted colors for providing a color coded reading of the temperature. In this setting, a color scale system ranging from a low body temperature to a high body temperature may be featured on the displaying surface so that an illumination of one particular color from that scale illustrates the baby's current body temperature.

Alternatively, numeric figures representative of the baby's body temperature (e.g., 98.6° F. and/or 37.5° C.) may be displayed for such showing as opposed to using the scale of different colors. A further variation for indicating the baby's body temperature is a hybrid between the color scale system and the numeric figures. Similar to the color scale system, this hybrid possesses a scale of different numeric figures in which an illumination of one particular numeric figure signifies the current state of the baby's body temperature.

In operation, the baby clothing of the present invention is used for monitoring the baby's body temperature for preventing serious health risks such as SIDS and/or sleep apnea while the baby is sleeping. However, it should be pointed out that the same may be applied while the baby is awake so as to constantly maintain an optimal level of body warmth. To monitor the baby's temperature, the parent may simply dress (if wearable item such as sleepwear) or cover (if covering item such as blanket) his or her baby with the baby clothing of the present invention.

Upon dressing or covering the baby, the measuring surface of its measuring member should be automatically placed upon the baby's body underneath the clothing. Simultaneously therewith, the displaying surface of its displaying member should also be automatically exposed externally upon the baby clothing. This by itself triggers the body temperature device to start measuring and displaying the baby's body temperature. If such specified positions are not obtained, then the parent should manually arrange the two members into those positions. Of course, the baby clothing of the present invention will keep monitoring the baby's temperature as long as it remains on the baby's body. Where impractical to place the measuring member directly on the baby's body, such as when the baby's clothing is layered, the measuring member will still communicate the temperature inside the clothing to the displaying member, providing valuable data to the parent regarding the baby's temperature inside the garment.

### BRIEF DESCRIPTION OF THE DRAWINGS

These as well as other features of the present invention will become more apparent upon reference to the drawings wherein:

FIG. 1 is a perspective view of an exemplary baby clothing constructed in accordance with a preferred embodiment of the present invention and featuring its clothing body which engages a body temperature device at an arbitrary location thereof;

FIG. 2 is a partial cross-sectional view of the temperature device of FIG. 1 constructed according to the third embodiment and illustrating its temperature measuring member and temperature displaying member which are placed on opposite sides of the clothing body and connected to each other via a flexible electrical line;

FIG. 3 is a partial cross-sectional view of the temperature device of FIG. 1 constructed according to the second embodiment and illustrating its displaying member which extends outward from its measuring member through the clothing body;

FIG. 4 is a perspective view of the temperature device of FIG. 1 constructed according to the first embodiment and illustrating its measuring and displaying members which are connected to each other via an elongated electrical rod;

FIG. 5 is a perspective view of the second embodied temperature device shown in FIG. 3 and illustrating its displaying member which is stacked upon its measuring member;

FIG. 6 is a perspective view of the second embodied temperature device shown in FIG. 5 and illustrating a layer of conductive material which may be optionally provided underneath its measuring member;

FIG. 7 is a perspective view of the third embodied temperature device shown in FIG. 2 and illustrating its measuring member as a generally round temperature measuring probe;

FIG. 8 is a perspective view of an alternative temperature device in the form of a generally rectangular thermometer which may be freely slipped in and out of a pocket of the clothing body;

FIG. 9 is a top view of the temperature device shown in FIG. 1 and illustrating its temperature displaying surface which possesses a color scale adapted to illuminate one particular color therefrom that is representative of the baby's current body temperature;

FIG. 10 is a top view of the temperature device shown in FIG. 1 and illustrating its displaying surface which is adapted to display numeric figures that are representative of the baby's current body temperature; and

FIG. 11 is a top view of the temperature device shown in FIG. 1 and illustrating its displaying surface which possesses a numeric scale adapted to illuminate numeric figures that are representative of the baby's current body temperature.

### DETAILED DESCRIPTION OF THE INVENTION

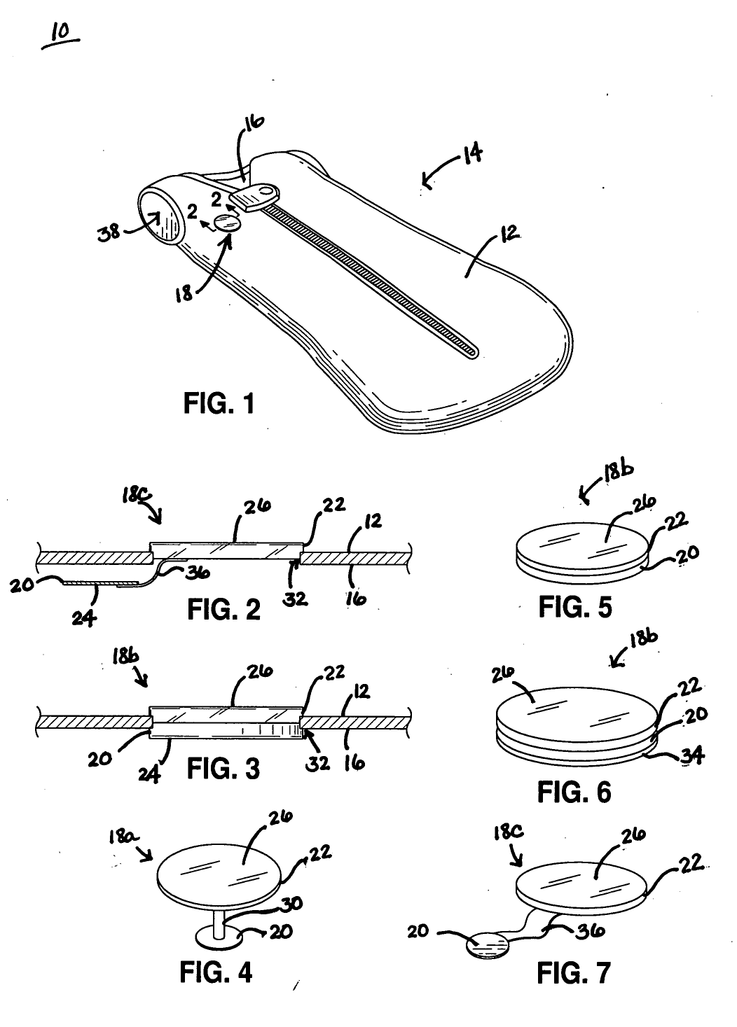

Referring now to the drawings wherein the showings are for purposes of illustrating embodiments of the present invention only, and not for purposes of limiting the same, FIG. 1 perspectively illustrates baby clothing 10 constructed in accordance with a first embodiment of the present invention. As indicated above, the present baby clothing 10 is adapted to accurately measure a temperature of a baby directly from his or her body and/or the temperature inside the clothing 10 and conveniently display the same upon an outer surface 12 of the clothing 10. As will be soon discussed, this noninvasive manner of monitoring the baby's body temperature is highly effective in preventing minor health risks such as common colds and/or flu, but more importantly safeguards the baby against major health risks such as Sudden Infant Death Syndrome (SIDS) and/or sleep apnea.

Before explaining the structural and functional characteristics of the present invention, for purposes of the description herein, the phrase “body temperature of the baby” or slight variations thereof relates to the temperature which is generated directly from the baby's body and/or the presence of temperature inside the clothing. Further, the word “clothing” is intended to be construed broadly to include any type of items which can partially or fully cover a baby or other person to provide either warmth or support. Specific examples of “clothing” include, but are in no way limited to, baby sleeping bags, baby blankets, baby carriers, baby slings and the like. Furthermore, the word “clothing” is not intended to be limited to baby clothing, but may be similarly used in other contexts such as for monitoring the temperatures of medical patients (e.g., bandages, hospital gowns, etc.), animals or pets (e.g., pet sweaters, pet blankets, pet pouches, pet carriers, etc.). It should also extend to athletes (e.g., uniforms, hats, jerseys, helmets, etc.) so as to monitor against the dangers of overheating during training and/or the actual game. The present invention relates to accurately measuring and conveniently displaying a body temperature by incorporating a temperature display device and its applicability may extend to a wide range of uses.

Preferably, however, the baby clothing 10 of the present invention is a sleepwear which is worn by the baby during sleep or nap times. Although various types of clothing may be employed for this purpose, it is recognized that parents often dress their babies in pajamas or sleep sacks before putting them to bed. However, the present baby clothing 10 should in no way be limited for sleeping, but may alternatively be a daywear which may be worn for daytime activities. Specific example of this would be a sweater, a jacket, a shirt, a hat, a beanie, etc.

Referring more particularly to FIGS. 1-3, the baby clothing 10 of the present invention includes a clothing body 14 having an inner clothing surface 16 and an outer clothing surface 12. The clothing body 14 is essentially designed to accommodate a baby's body therewithin. As such, the clothing body 14 may be provided in a plurality of sizes to complement different body sizes of the babies. Moreover, it should be further indicated that the clothing body may be fabricated from all types of materials currently known and used in the baby clothing industry (e.g., fabric or leather).

The baby clothing 10 of the present invention further includes a body temperature device 18. Such temperature device 18 is provided primarily for monitoring the baby's body temperature. As specifically illustrated in FIGS. 2 and 3, the body temperature device 18 is engaged to the clothing body 14 in a specific manner as to (1) measure the temperature directly from the baby's body and/or the temperature inside the clothing, and (2) display such temperature measurement upon the outer clothing surface 12 of the clothing body 14. This specified manner of engagement allows the baby's temperature to be accurately assessed and further allows a parent to conveniently observe the baby's temperature without the need to unzip or unbutton the clothing 10.

Any conventional methods may be utilized for engaging the body temperature device 18 to the clothing body 14. For example, the temperature device 18 may be sewn or otherwise affixed to the clothing body 14 (e.g., removably snapped on the clothing body 14). It should be expressly stated herein that the body temperature device 18 may be engaged at various locations of the clothing body 14 and is in no way limited to what is shown in FIG. 1. More specifically, the temperature device 18 may be placed at any location of the clothing body 14 such as at its upper or lower corner locations, or even at its upper intermediate portion.

Referring now to FIGS. 4-8, the body temperature device 18 incorporated into the present baby clothing 10 may be constructed in accordance with multiple embodiments to achieve the above-described manner of engagement to the clothing body 14. More particularly, there are described herein three specific embodiments of construction which conform to the following general specifications. Prior to explaining the specific construction of each of the different embodiments, the general specifications in which they must all follow are described below.

In all the embodiments of the body temperature device 18, the body temperature device 18 is comprised of a temperature measuring member 20 and a temperature displaying member 22. These two members 20, 22 are placed on opposite sides of the clothing body 14, that is, the measuring member being positioned adjacent the inner clothing surface 16 and the displaying member being positioned adjacent the outer clothing surface 12.

Referring now back to FIGS. 2 and 3, the body temperature device 18 places its measuring member 20 between the baby's body and the inner surface 16 of the clothing body 14. When forming such configuration, a temperature measuring surface 24 of the measuring member 20 is preferably positioned closely adjacent the baby's body, and more preferably abutted against the baby's body. The temperature measuring surface 24 is configured to monitor the baby's body temperature continuously for a prolonged amount of time, or at least until the present clothing 10 is taken off from the baby.

In further describing the general specifications characterizing all the differing embodiments of the body temperature device 18, it should be noted that the temperature displaying member 22 is preferably positioned on or through the outer surface 12 of the clothing body 14. In either of these configurations, a temperature displaying surface 26 becomes exposed externally upon the outer surface 12 of the clothing body 14. This makes the temperature displaying surface 26 readily visible by the parent, hence providing the parent with the tangible temperature reading of his or her baby.

The temperature displaying member 22 is placed in electrical communication with the temperature measuring member 20. Due to such electrical connection, the displaying member 22 is operative to continuously receive the body temperature measurements from the measuring member 20. Upon receiving the measurements, the temperature displaying member 22 displays visual indicia 28, which are representative of the temperature measurements, through its displaying surface 26 for the parents to observe. The details of the visual indicia 28 will be better discussed later.

As shown in FIGS. 4-8, the generally specified framework of the body temperature device 18, as well as the required positioning of its measuring and displaying members 20, 22, may be achieved through various constructions of the temperature device 18. Turning now to each embodiment of the body temperature device 18, FIG. 4 illustrates a body temperature device 18a constructed in accordance with a first embodiment. The first embodied temperature device 18a possesses a temperature displaying member 22 which is larger in size than its corresponding temperature measuring member 20. Although they may be variously configured, the measuring and displaying members 20, 22 in this embodiment are each preferably formed to have a generally circular configuration. More distinctive to the first embodiment, however, is an electrical rod 30 which is provided between the measuring and displaying members 20, 22, and operates to electrically communicate the two members together. The electrical rod 30 may be extended through one of the holes 32 which is either preformed on the clothing 10 (e.g., button hole) or created after the clothing 10 is manufactured. Alternatively, the electrical rod 30 may be removably snapped on the clothing 10.

FIG. 5 illustrates a body temperature device 18b which is constructed in accordance with a second embodiment. The measuring and displaying members 20, 22 of the second embodied temperature device 18b are simply stacked upon each other. In this respect, the temperature displaying member 22 extends out from the temperature measuring member 20 through one of the holes 32 of the clothing body 14. This exposes the temperature displaying surface 26 upon the outer surface 12 of the clothing body 14. Alternatively, this embodiment 18b may also be attached to the clothing 10 magnetically without the presence of a hole 32 in the clothing 10. Preferably, the two members 20, 22 in this embodiment also have a generally round configuration.

Optionally, the temperature measuring member 20 of the second embodied temperature device 18b may include a conductive layer 34 so as to increase the accuracy in measuring the baby's body temperature (shown in FIG. 6). Although various types of conductive material may be used for this purpose, it is preferred that the conductive layer 34 is fabricated from a metallic material, and more preferably aluminum. However, this feature of the temperature device 18b is strictly optional, and not mandatory. Although various attachment procedures may be used, clips or adhesive strips may be utilized to keep the measuring member 20 in contact with the baby's body.

A body temperature device 18c constructed in accordance with a third embodiment is portrayed in FIG. 7. In this embodiment, a flexible electrical line 36 is utilized for communicating the separated measuring and displaying members 20, 22 of the body temperature device 18c. The flexible electrical line 36 may be extended through one of the holes 32 of the clothing body 14, or extend around the clothing body 14 and be inserted into one of its openings 38 such as the arm opening.

Due to the flexible elongation of the electrical line 36, the displaying member 22 may be alternatively tucked into one of the pockets 40 prefabricated or post-fabricated on the clothing body 14 rather than being sewn or engaged. More specifically, the flexible electrical line 36 may be extended out from the pocket 40 for insertion into one of the holes 32 or openings 38. This allows the body temperature device 18 to be feasibly removed from the clothing body 14 which becomes very useful in certain situations such as when the temperature device 18 is in need of a repair or when the clothing 10 is in need of a wash. Preferably, the temperature displaying member 22 in this embodiment has a generally circular configuration and its corresponding measuring member 20 is a generally circular and small temperature measuring probe.

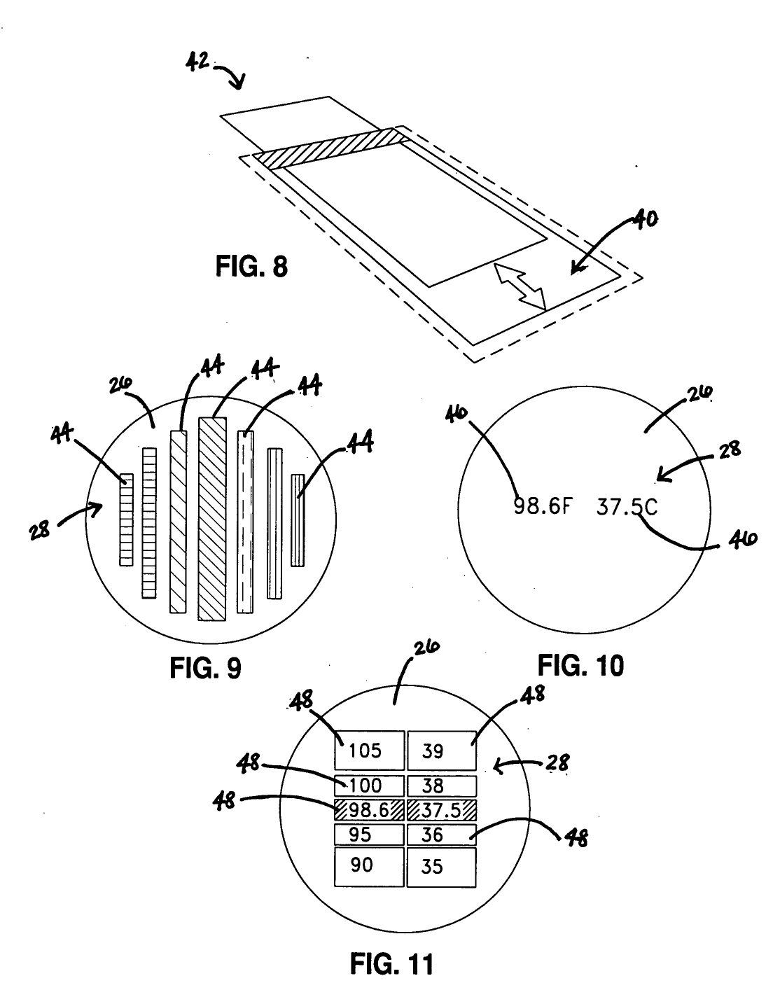

FIG. 8 shows an alternative body temperature device 42 which is essentially a thermometer that can be freely slipped in and out of one of the clothing body's pocket 40. This thermometer has a generally rectangular configuration so that it may better correspond to conventional preformed pockets 40 in shape and configuration. Although this version of the temperature device 42 does not conform to the general specifications as extensively discussed above, it is nonetheless a possible variation which may be workable with the baby clothing 10 of the present invention.

Referring now to FIGS. 9-11, the visual indicia 28 may be presented in various forms upon the temperature displaying surface 26. One form of visual indicia 28 that may be used to visualize the baby's body temperature is a scale system of assorted colors (shown in FIG. 9). This color scale system provides a color coded reading of the baby body's temperature. In this setting, the temperature displaying surface 26 is preferably a color changing liquid crystal display surface with an array of differently illuminable color panels 44. These color panels 44 are arranged in an order which illustrates a range from a low body temperature to a high body temperature. In this respect, an illumination of one particular color panel 44 from the color scale system would show the baby's current body temperature. For instance, if the red color panel becomes lit, then this may indicate that the body temperature is high. Likewise, if the blue color panel becomes lit, then this may indicate a cold body temperature. An illumination of the green color panel may show a preferred body temperature of the baby.

Alternative to the color scale system, FIG. 10 shows a different approach to visual representation. In particular, numeric figures 46 representative of the baby's body temperature (e.g., 98.6° F. and/or 37.5° C.) may be displayed in lieu of color illuminations. FIG. 11 illustrates a further variation for indicating the baby's body temperature which is essentially a hybrid between the color scale system and the numeric figures. Similar to the color scale system, this hybrid possesses a scale of different numeric figures 48 in which an illumination of one particular numeric figure signifies the current state of the baby's body temperature.

In operation, the baby clothing 10 of the present invention is used for monitoring the baby's body temperature primarily for preventing serious health risks such as SIDS and/or sleep apnea while the baby is sleeping. However, it should be pointed out that the present clothing 10 may be applied when the baby is awake so as to constantly maintain an optimal level of body warmth. To monitor the baby's temperature, the parent may simply dress (if wearable item such as sleepwear) or cover (if covering item such as blanket) his or her baby with the baby clothing 10 of the present invention.

Upon dressing or covering the baby, the temperature measuring surface 24 of the temperature measuring member 20 is automatically placed upon the baby's body underneath the inner surface 16 of the baby clothing 10. Simultaneously therewith, the temperature displaying surface 26 of the temperature displaying member 22 is also automatically exposed externally upon the outer surface 12 of the baby clothing 10. This should by itself trigger the body temperature device 18 to start measuring and displaying the baby's body temperature. If such specified positions are not obtained, then the parent should manually arrange the measuring and displaying members 20, 22 into those positions. Of course, the baby clothing 10 of the present invention will keep monitoring the baby's temperature as long as it remains on the baby's body.

Additional modifications and improvements of the present invention may also be apparent to those of ordinary skill in the art. Thus, the particular combination of parts described and illustrated herein is intended to represent only certain embodiments of the present invention, and is not intended to serve as limitations of alternative devices within the spirit and scope of the invention.

1. Clothing for measuring and displaying body temperature comprising:
a. a sleep sack sized and configured to accommodate a mammalian body therewithin; and
b. a body temperature device engaged to the sleep sack and having a temperature measuring member and a temperature displaying member, the temperature measuring member being disposed in contact with the mammalian body for measuring the temperature of the mammalian's body, the temperature displaying member being in communication with the temperature measuring member for receiving the temperature measurement of the mammalian's body therefrom, the temperature displaying member having a temperature displaying surface visible from outside the sleep sack for displaying a visual indicia representative of the temperature of the mammalian's body.

2. The clothing of claim 1 wherein the body temperature device measures and displays the temperature of the baby's body when the baby is asleep.

3. (canceled)

4. (canceled)

5. The clothing of claim 1 wherein the body temperature device measures and displays the temperature of the baby's body when the baby is awake.

6. The clothing of claim 1 wherein a flexible electrical line communicates the temperature displaying member and the temperature measuring member with each other, the flexible electrical line being extendable from the temperature displaying member to the temperature measuring member when the body temperature device is engaged to the clothing body.

7. The clothing of claim 6 wherein the sleep sack has at least one pocket, the temperature displaying member being removably retainable within the at least one pocket.

8. The clothing of claim 7 wherein the sleep sack defines an inner clothing surface and the flexible electrical line is sized and configured to extend from the temperature displaying member retained within the at least one pocket to the temperature measuring member disposed between the baby's body and the inner clothing surface.

9. The clothing of claim 8 wherein the temperature measuring member is a temperature measuring probe.

10. The clothing of claim 1 wherein the sleep sack defines an inner clothing surface and the temperature measuring member has a temperature measuring surface sized and configured to contact a baby's body underneath the inner clothing surface for measuring the temperature of the baby's body.

11. The clothing of claim 10 wherein the temperature measuring surface comprises a layer fabricated from a conductive material.

12. The clothing of claim 11 wherein the conductive material is aluminum.

13. The clothing of claim 10 wherein the sleep sack defines an outer clothing surface and the temperature displaying member is sized and configured to extend from the temperature measuring member for exposing the temperature displaying surface outside the baby's body and upon the outer clothing surface.

14. Clothing for measuring and displaying a body temperature of a mammal comprising:
a. a clothing body sized and configured to accommodate a body of the mammal therewithin;
b. a body temperature device having a temperature measuring member and a temperature displaying member, the temperature measuring member adjacently disposable to the mammal body for measuring the temperature of the mammal body, the temperature displaying member being in communication with and fixedly stacked upon the temperature measuring member, the temperature displaying member being in communication with the temperature measuring member for receiving the temperature measurement of the mammal body therefrom, the temperature displaying member having a temperature displaying surface visible from outside the clothing body for displaying a visual indicia representative of the temperature of the mammal body.

15. The clothing of claim 13 wherein an elongated electrical rod is disposed between the temperature displaying member and the temperature measuring member for communication therebetween.

16. The clothing of claim 1 wherein the temperature measuring member has a generally circular configuration.

17. The clothing of claim 1 wherein the temperature displaying member has a generally circular configuration.

18. The clothing of claim 1 wherein the visual indicia displayed on the temperature displaying surface is a numeric figure representative of the temperature of the mammalian's body.

19. The clothing of claim 1 wherein the visual indicia displayed on the temperature displaying surface is a color scale sized and configured to illuminate a particular color representative of the temperature of the mammalian's body.

20. The clothing of claim 1 wherein the visual indicia displayed on the temperature displaying surface is a numeric scale sized and configured to illuminate a particular numeric figure representative of the temperature of the mammalian's body.

21. Clothing for measuring and displaying a body temperature of a mammal comprising:
a. a body temperature device having a temperature measuring device and a temperature displaying member, the temperature measuring member adjacently disposable to a body of the mammal for measuring the mammal body temperature, the temperature displaying member being in communication with the temperature measuring member for receiving the temperature measurement of the mammal body therefrom, the temperature displaying member having a temperature displaying surface for displaying a visual indicia representative of the temperature of the mammal body; and
b. a clothing body sized and configured to accommodate the mammal body therewithin, the clothing body having an aperture sized and configured to receive only the body temperature device therethrough.

22. The clothing of claim 21 wherein the temperature displaying member is in communication with the temperature measuring member via a conductor.

23. The clothing of claim 22 wherein the conductor is a wire.

24. The clothing of claim 22 wherein the conductor is a rod.

25. The clothing of claim 22 wherein the conductor is removeably snapped onto the clothing body.

26. Clothing for measuring and displaying a body temperature of a mammal comprising:
a. a clothing body sized and configured to accommodate a body of the mammal therewithin, the clothing body having an aperture defining an outer perimeter; and
b. a body temperature device engageable to the aperture outer perimeter, the device having a temperature measuring member and a temperature displaying member, the temperature measuring member being adjacently disposable to the mammal body for measuring the temperature of the mammal body, the temperature displaying member being in communication with the temperature measuring member for receiving the temperature measurement of the mammal body therefrom, the temperature displaying member having a temperature displaying surface visible from outside the clothing body for displaying a visual indicia representative of the temperature of the mammal body.

27. The clothing of claim 26 wherein the temperature displaying member engages the aperture outer perimeter.
